(19) United States
(12) Patent Application Publication
(10) Pub. No.: US 2010/0207988 A1
(43) Pub. Date: Aug. 19, 2010

(54) INK-JET RECORDING APPARATUS

(75) Inventors: Masashi Hiroki, Yokohama-shi (JP); Satoshi Kaiho, Yokohama-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/769,792

(22) Filed: Apr. 29, 2010

Related U.S. Application Data
(62) Division of application No. 11/619,711, filed on Jan. 4, 2007.

(51) Int. Cl. B41J 2/205; B41J 2/175

(52) U.S. Cl. 347/15; 347/86

(57) ABSTRACT

An ink-jet recording apparatus includes plural cartridge loading units respectively corresponding to plural ink cartridges and configured in such a manner that the respective ink cartridges are loaded therein in a reloadable manner, ink inflow ports provided to the respective plural cartridge loading units to introduce the inks accommodated in the ink cartridges to be supplied to the plural heads when connected to ink outflow ports provided to the ink cartridges, a detection unit configured to detect whether the ink cartridges are loaded in the cartridge loading units as predetermined before the ink outflow ports come into contact with the ink inflow ports when the ink cartridges are loaded in the cartridge loading units, and a notifying unit configured to notify a detection result of the detection unit in a form of a display or a sound.

### CROSS-REFERENCE TO RELATED APPLICATIONS

This application is a Division of application Ser. No. 11/619,711 filed Jan. 4, 2007, the entire contents of which is hereby incorporated by reference.

### BACKGROUND OF THE INVENTION

1. Field of the Invention

The present invention relates to an ink-jet recording apparatus having a reloadable ink cartridge to serve as an apparatus for printing an image on a sheet of paper, for example, a print sheet, and more particularly, to such an apparatus in which an ink cartridge can be loaded properly.

2. Description of the Related Art

In a case where a printer apparatus is capable of performing color printing, for example, four kinds of ink cartridges respectively storing inks in four colors including yellow, magenta, cyan, and black, are prepared, and these ink cartridges are loaded in four cartridge accommodation units provided correspondingly to the respective colors on the printer apparatus side by matching the colors. Inks accommodated in the ink cartridges of respective colors are supplied to the corresponding ink-jet heads by supply devices provided to the respective cartridge accommodation units.

When the respective ink cartridges are loaded in the cartridge accommodation units, in order to prevent the ink cartridge from being loaded erroneously in the cartridge accommodation unit for a different color, as is disclosed, for example, in JP-A-2001-088317 (Reference 1), each ink cartridge has a different shape, so that the ink cartridge is engaged in the cartridge accommodation unit only when the ink cartridge is loaded in the corresponding cartridge accommodation unit for a right color.

Also, JP-A-2006-181718 (Reference 2) discloses a method, by which a memory unit to store information is provided to the ink cartridge and the information in the memory unit is read on the printer side, so that the user is notified of the information when a wrong ink cartridge is loaded.

Further, JP-A-2006-116787 (Reference 3) discloses a method, by which the ink cartridges are common for all the colors, and completion of a loading operation of the ink cartridge is indicated as soon as the loading operation is completed.

When an ink cartridge is loaded in a wrong cartridge accommodation unit, there arises a problem that different inks are mixed and the inks change in nature and clog an ink supply channel. In this regard, the technique disclosed in Reference 1 is effective. However, the cost increases because the ink cartridge cannot be made common. Moreover, as the recording apparatus or the ink cartridges are reduced in size and the number of ink colors is increased to four or more, it becomes only possible to provide a slight difference to the shapes of the ink cartridges. Hence, whether the ink cartridge is a right one or wrong one cannot be determined unless the loading operation is performed several times.

The technique disclosed in Reference 2 can save the cost because the ink cartridges can be common, and makes it possible to notify the user of the information when a wrong ink cartridge is loaded.

The technique disclosed in Reference 3 enables the user to confirm whether the ink cartridge is loaded properly as soon as the loading operation is completed. However, because the loading of a wrong ink cartridge is informed only after the ink on the ink cartridge side comes into contact with a different ink on the ink accommodation unit side, there is a problem that the inks are deteriorated at the contact portion.

An object of the invention is to provide an ink-jet recording apparatus not only capable of reducing the cost by making the shapes of the ink cartridges common for all the colors, but also capable of eliminating deterioration of inks inside the printer main body by preventing an ink cartridge from being loaded in a wrong accommodation unit so as to avoid a contact between the ink on the ink cartridge side and a different ink on the ink accommodation unit side.

### BRIEF SUMMARY OF THE INVENTION

One aspect of the invention is an ink-jet recording apparatus that performs recording on a recording medium by introducing inks from plural ink cartridges respectively accommodating inks in plural different colors, including: plural heads that eject the inks in plural colors toward the recording medium; plural cartridge loading units respectively corresponding to the plural ink cartridges and configured in such a manner that the respective ink cartridges are loaded therein in a reloadable manner; ink inflow ports provided to the respective plural cartridge loading units to introduce the inks accommodated in the ink cartridges to be supplied to the plural heads when connected to ink outflow ports provided to the ink cartridges; a detection unit configured to detect whether the ink cartridges are loaded in the cartridge loading units as predetermined before the ink outflow ports come into contact with the ink inflow ports when the ink cartridges are loaded in the cartridge loading units; and a notifying unit configured to notify a detection result of the detection unit in a form of a display or a sound.

Objects and advantages of the invention will become apparent from the description, which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a view schematically showing an ink-jet recording apparatus according to one embodiment of the invention;

FIG. 2 is a cross section of a cartridge loading unit incorporated in the ink-jet recording apparatus when viewed from the front;

FIG. 3 is a cross section of the cartridge loading unit when viewed from the side surface;

FIG. 4 is a front view showing a terminal portion of the cartridge loading unit;

FIG. 5 is a perspective view showing an ink cartridge loaded in the ink-jet recording apparatus;

FIG. 6 is a cross section of the ink cartridge when viewed in the side surface direction;

FIGS. 7A through 7D are front views each showing a plate attached to the ink cartridge;

FIG. 8 is a cross section showing the positional relation of the ink cartridge and the cartridge loading unit in a first stage when viewed in the side surface direction;

FIG. 9 is a cross section showing the positional relation of the ink cartridge and the cartridge lading unit in a second stage when viewed in the side surface direction;

FIG. 10 is a cross section of a major portion showing the positional relation of a seal and a valve of the ink cartridge and an ink receiving unit in a state of FIG. 9;

FIG. 11 is an explanatory view schematically showing a route of an ink from the cartridge loading unit to a head;

FIG. 12 is a perspective view showing a state where the ink cartridge is loaded in the cartridge loading unit;

FIG. 13 is a block diagram showing a control system of the ink-jet recording apparatus;

FIG. 14 is a plan view showing patches formed at several grayscale levels on a sheet of paper using the ink-jet recording apparatus;

FIG. 15 is a flowchart showing a calibration operation in the ink-jet recording apparatus;

FIG. 16 is a flowchart showing the calibration operation performed for different kinds of paper in the ink-jet recording apparatus;

FIG. 17 is a flowchart showing a printing operation using calibration data in the ink-jet recording apparatus; and

FIG. 18 is a cross section of the cartridge loading unit according to a modification of the embodiment when viewed in the side surface direction.

### DETAILED DESCRIPTION OF THE INVENTION

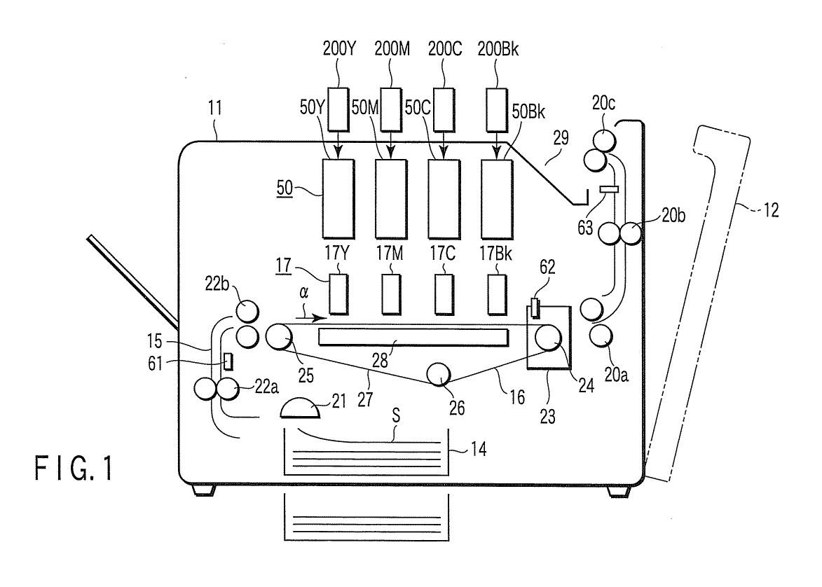

Hereinafter, an ink-jet recording apparatus (image forming apparatus) according to one embodiment of the invention will be described in reference to FIG. 1 through FIG. 17. FIG. 1 is a view schematically showing an ink-jet recording apparatus 10. The ink-jet recording apparatus 10 includes a housing 11. The housing 11 is provided with a lid 12 for maintenance use, and it is configured in such a manner so as to facilitate the cleaning of a discharge unit 20 described below.

The housing 11 is provided with cartridge loading units 50Y, 50M, 50C, and 50Bk, a paper storing unit 14 in which recording media S are set, a paper feeding unit 15 that feeds a recording medium S from the paper storing unit 14, a medium carrying unit 16 that carries a recording medium S fed from the paper feeding unit 15, a color ink-jet recording head mechanism 17 that ejects an ink E onto a recording medium S carried by the medium carrying unit 16, a discharge unit 20 that discharges a recording medium S, and a control device 100 that controls the foregoing components in a cooperative manner.

Cartridges 200Y, 200M, 200C, and 200Bk described below are loaded in a reloadable manner in the cartridge loading units 50Y, 50M, 50C, and 50Bk, respectively.

The paper feeding unit 15 is configured to separate the recording media S set in the paper storing unit 14 one by one from the top using a separation roller 21, and to feed the recording medium S to the medium carrying unit 16 using two paper feeding roller pairs 22a and 22b. The medium carrying unit 16 is formed of a drive roller 24 and a driven roller 25 driven by a stepping motor 23, a driven roller 26 to which a tensile force is conferred from an unillustrated spring, and a medium carrying belt 27 stretched over the drive roller 24 and the driven rollers 25 and 26 and provided with holes made at regular intervals on the surface thereof.

On the inner side of the medium carrying belt 27, a medium attraction plate 28 is disposed so as to come into contact with the medium carrying belt 27, and by sucking air from the inner side of the medium carrying belt 27, it attracts a recording medium S on the outer side of the medium carrying belt onto the medium carrying belt 27 via the holes in the medium carrying belt 27.

It is configured in such a manner that the recording medium S is carried in a direction indicated by an arrow α in the drawing while being attracted onto the medium carrying belt 27 to pass by an opposing position to the color ink-jet recording mechanism 17, after which it is discharged to a discharged paper receiving unit 29 with the use of discharge rollers 20a, 20b, and 20c that together form the discharge unit 20.

The color ink-jet recording head mechanism 17 includes ink-jet recording heads 17Y, 17M, 17C, and 17Bk that perform printing using inks E in four colors including yellow, magenta, cyan, and black, and are disposed above the medium carrying belt 26 sequentially in this order from upstream to downstream in the carrying direction of the recording medium S.

These ink-jet recording heads 17Y, 17M, 17C, and 17Bk are line-type heads in which a large number of fine liquid ejection ports, that is, nozzles, are aligned in a direction orthogonal to the carrying direction of the recording medium S across a width sufficiently large enough to cover the full width of the recording medium S, and they are configured to eject inks E in the respective colors from the nozzles. The respective ink-jet recording heads 17Y, 17M, 17C, and 17Bk eject inks E from the nozzles using, for example, a pressure generation unit formed of an electromechanical transducer, such as a piezoelectric element.

Referring to FIG. 1, numeral 61 denotes a media sensor that determines a kind of paper from a thickness and a surface roughness of the paper, numeral 62 denotes a color sensor that detects chromaticity, color saturation, brightness, and so forth of an image printed on a sheet of paper S, and numeral 63 denotes a jamming sensor that detects jamming of a sheet of paper. The color sensor 62 and the jamming sensor 63 may be provided as a single unit.

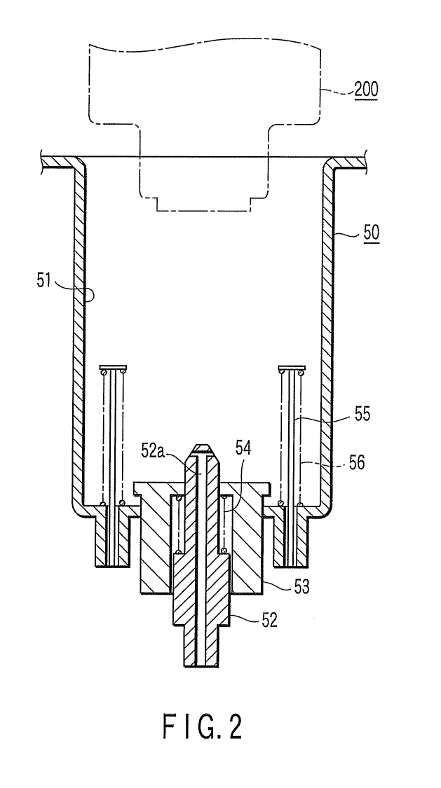

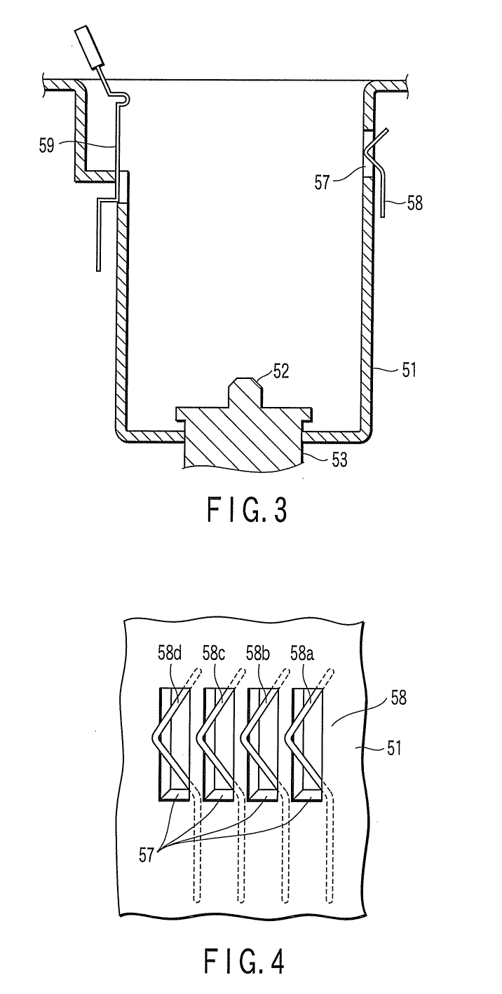

FIG. 2 is a cross section of a cartridge loading unit 50 of the ink-jet recording apparatus 10 when viewed from the front, and FIG. 3 is a cross section when viewed from the side surface. The cartridge loading unit 50 is provided with a concave portion 51 that supports the outer peripheral surface of the ink cartridge 200 on the inner peripheral surface, and a shaft-shaped ink receiving unit (second stage loading unit) 52 provided at the bottom surface of the concave unit 51. The ink receiving unit 52 is provided with an ink flow channel 52a at the shaft center, and it is formed in such a manner that the tip end is inserted into a seal 245 of the ink cartridge 200. A seal auxiliary unit 53 is provided around the ink receiving unit 52 so as to be able to slide in the vertical direction with respect to the ink receiving unit 52, and it is kept pushed upward by a coil spring 54. Damper units (first stage loading unit) 55 that come into contact with the bottom portion of the ink cartridge 200 are provided to two portions on the both sides of the seal assist unit 53. The damper units 55 are kept pushed upward in FIG. 2 by coil springs 56.

As is shown in FIG. 3, slits 57 are provided to the concave unit 51 in the surface opposing the back surface of the ink cartridge 200, and a terminal unit 58 that detects information about the ink cartridge 200 from the slits 57 is provided. As is shown in FIG. 4, the terminal unit 58 includes terminals 58a through 58d and each protrudes from the slits 57 in such a manner that their bending portions come into contact with a plate 220 described below. In addition, a blade spring 59 that fixes the loaded ink cartridge 200 is provided to the surface opposing the front of the ink cartridge 200.

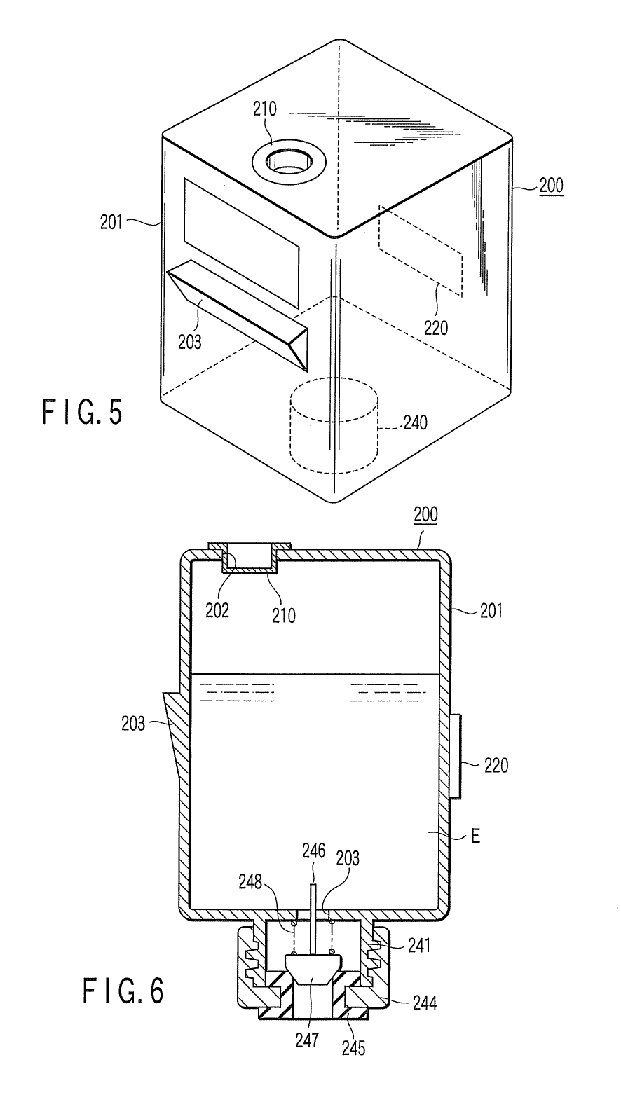

FIG. 5 is a perspective view showing the ink cartridge 200, and FIG. 6 is a cross section in the side surface direction. As inks E accommodated in the ink cartridges 200, typical oil-based and aqueous inks for ink-jet recoding use can be used. Oil-based ink composites are made of a non-aqueous organic solvent, a coloring agent, a dispersing agent, and various additive agents. Aqueous ink composites are made of a coloring agent, ion-exchanged water as a solvent, a water-soluble organic solvent, and various additive agents. Both dyes and pigments can be used as the coloring agent.

The ink cartridge 200 includes a housing 201 in the shape of a square prism. A hole 202 for supplying the ink E is made in the top surface of the housing 201, and it is closed with a cap 210 after the ink E is replenished therein. A protrusion 203 that fixes the housing 201 to the cartridge loading unit 50 is provided to the front surface. Further, the plate 220 having stored information about the ink cartridge 200 is attached to the back surface.

A discharge port 203 for discharging the ink E is provided in the bottom surface of the ink cartridge 200, and a valve mechanism 240 is provided to surround the discharge port 203. The valve mechanism 240 is formed in the shape of a circular column, and includes a valve main body 241 provided with a male screw on the outside, a cap 244 provided with a female screw that is threaded into the valve main body 241, and a seal 245 made of rubber and attached to the entire circumference of the hole in the cap 244.

A shaft 246 passing through the discharge port 203, a valve 247 made of rubber and attached to the shaft 246 at the lower end in the drawing, and a coil spring 248 that pushes the valve 247 toward the seal 245 are provided inside the valve main body 241. In a case where the ink cartridge 200 is removed from the ink-jet recording apparatus 10, the valve 247 is pressed against the seal 245 by the coil spring 248, so that the ink E is accommodated liquid-tight in the housing 11.

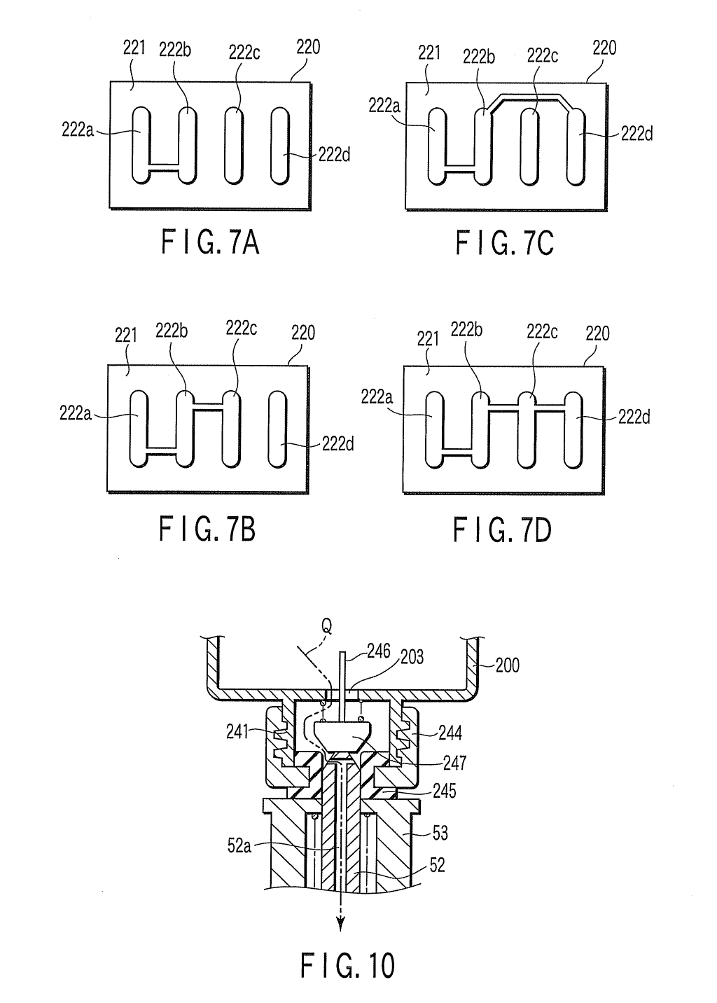

FIGS. 7A through 7D are front views of the plate 220. The plate 220 includes a substrate 221, and four conductive patterns 222a through 222d are aligned side by side in the horizontal direction on the surface thereof. The connection pattern connecting these four conductive patterns 222a through 222d varies with the color of the ink E stored in the ink cartridge 200. For example, in a case where Y is the color of the ink, the conductive portions 222a and 222b alone are connected as is shown in FIG. 7A. In a case where M is the color of the ink, three points at the conductive portions 222a, 222b, and 222c are connected as is shown in FIG. 7B. In a case where C is the color of the ink, three points at the conductive portions 222a, 222b, and 222d are connected as is shown in FIG. 7C. In a case where Bk is the color of the ink, four points at the conductive portions 222a, 222b, 222c, and 222d are connected as is shown in FIG. 7D.

An inserting operation to load the ink cartridge 200 in the cartridge loading portion 50 will now be described.

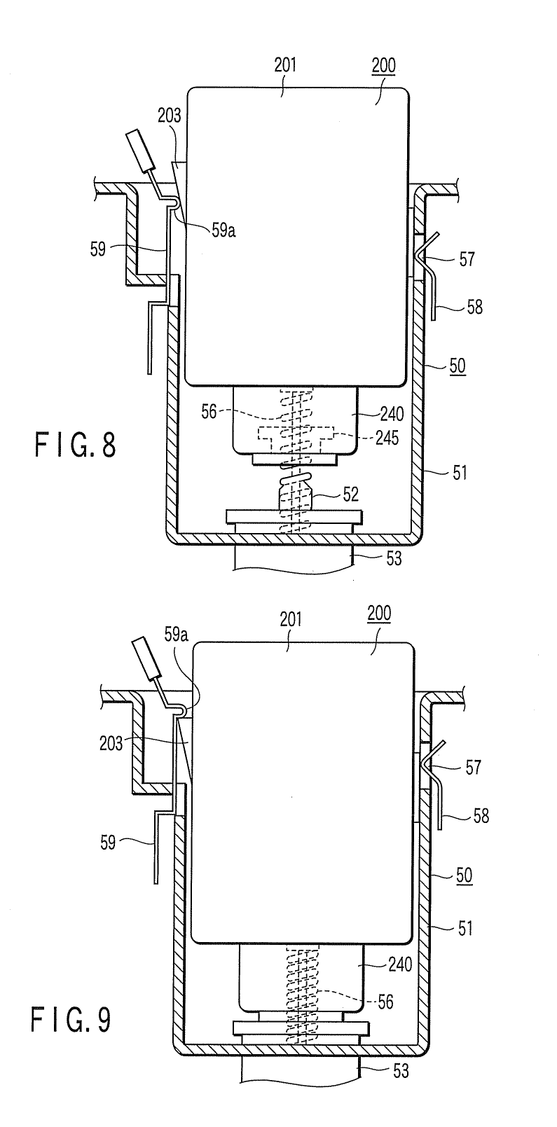

FIG. 8 is a cross section showing the positional relation of the ink cartridge 200 and the cartridge loading unit 50 in a first stage at which the ink cartridge 200 is inserted into the cartridge loading unit 50 when viewed in the side surface direction. When the ink cartridge 200 is inserted into the cartridge loading unit 50 from above, the bottom surface of the housing 201 of the ink cartridge 200 comes into contact with the damper units 55. The coil springs 56 that keep pushing the damper units 55 in the direction toward the ink cartridge 200 are set at a spring constant high enough not to be compressed merely by the weight of the ink cartridge 200 including the ink E. In the first stage, as the plate 43 having stored the information about the ink cartridge 200 comes into contact with the terminal 58 that detects the information, the information is read out and the color of the ink accommodated in the ink cartridge 200 is determined. It should be noted that in this state, the seal 45 at the bottom portion of the ink cartridge 200 is out of contact with the ink receiving unit 52 of the cartridge loading unit 50.

FIG. 9 is a cross section showing the positional relation of the ink cartridge 200 and the cartridge loading unit 50 in a second stage at which the ink cartridge 200 is inserted into the ink cartridge loading unit 51 when viewed in the side surface direction. When the ink cartridge 200 is inserted further downward against restoring forces of the coil springs 56 that keep pushing the damper units 55 upward, the ink receiving unit 52 of the cartridge loading portion 50 is inserted into the seal 45 at the bottom of the ink cartridge 200. In this state, the protrusion 42 on the front of the ink cartridge 200 is engaged in a curved unit 59a in the blade spring 59. Hence, in spite of the restoring forces of the coil springs 56 that keep pushing the ink cartridge 200 upward, the position of the ink cartridge 200 is fixed. Also, the contact between the plate 43 having stored the information about the ink cartridge 200 and the terminal 58 that detects the information is maintained for the information to be read out.

FIG. 10 is a cross section of a major portion showing the positional relation of the seal 45 and the valve 47 of the ink cartridge 200 and the ink receipting unit 52 in the state of FIG. 9. After the ink receiving unit 52 is inserted into the seal 45, the tip end of the ink receiving unit 52 pushes up the valve 47, so that the ink E inside the ink cartridge 200 flows into the ink flow channel 52a inside the ink receiving unit 52 via a route indicated by a chain double-dashed line Q.

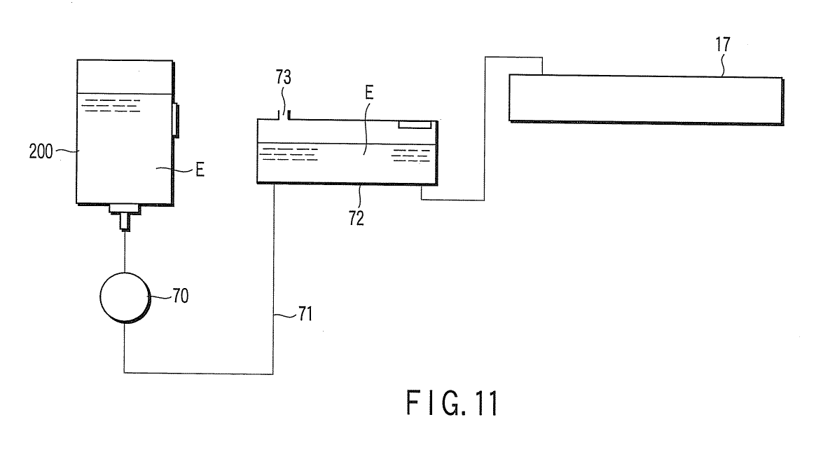

FIG. 11 is an explanatory view schematically showing the route for the ink E introduced as described above from the cartridge loading unit 50 to the head 17. The ink E flowed out from the ink cartridge 200 by passing through the ink receiving unit 52 is supplied to an ink tank 72 via an ink supply tube 71 by a pump 70. The pump 70 supplies the ink E to the ink tank 72 when operating, and blocks the flow of the ink E when at rest or the power supply is OFF. For example, such a circumstance can be provided by a piston pump or a tube pump.

In addition, the pump 70 performs an ink supply operation only when the ink cartridge 200 is loaded in the cartridge loading unit 50 at the right position. The ink tank 72 is provided with a releasing unit 73 in part so that the ink surface is at atmospheric pressure. Further, a sensor 74 that detects the level of the liquid surface of the ink E is attached. The ink tank 72 is linked to the ink-jet recording head 17 via an ink supply tube 75, and the level of the liquid surface of the ink E inside the ink tank 72 is adjusted so that the meniscus on the nozzle surface of the ink-jet recording head 17 is at a negative pressure with respect to the ink E inside the ink tank 74.

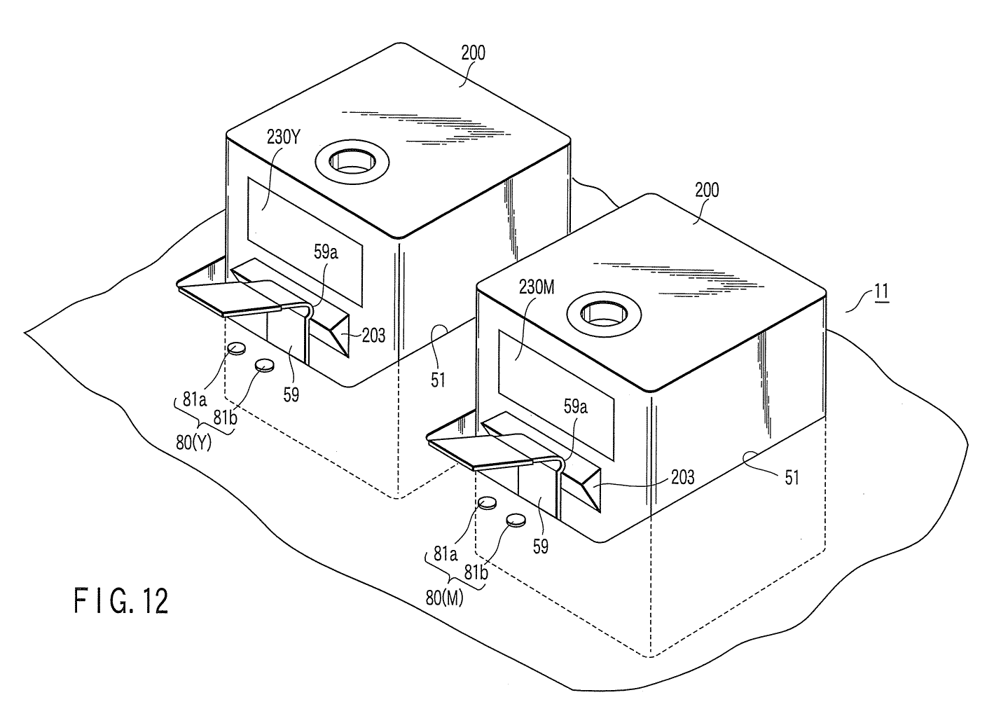

FIG. 12 is a perspective view showing a state where the ink cartridge 200 is loaded in the cartridge loading unit 50. As has been described with reference to FIG. 9, the blade spring 59 is engaged in the protrusion 42 of the ink cartridge 200. Also, a display unit 80 for the ink cartridge 200 to display the loading information is provided to each cartridge loading unit 50 at the front of the ink cartridge 200. The display unit 80 includes LEDs 81a and 81b. Because the display unit 80 indicates whether the ink cartridge 200 is inserted into the right cartridge loading unit 50, it is preferable to dispose the display unit 80 in close proximity to the front of the ink cartridge 200 by taking the viewability for the user into account.

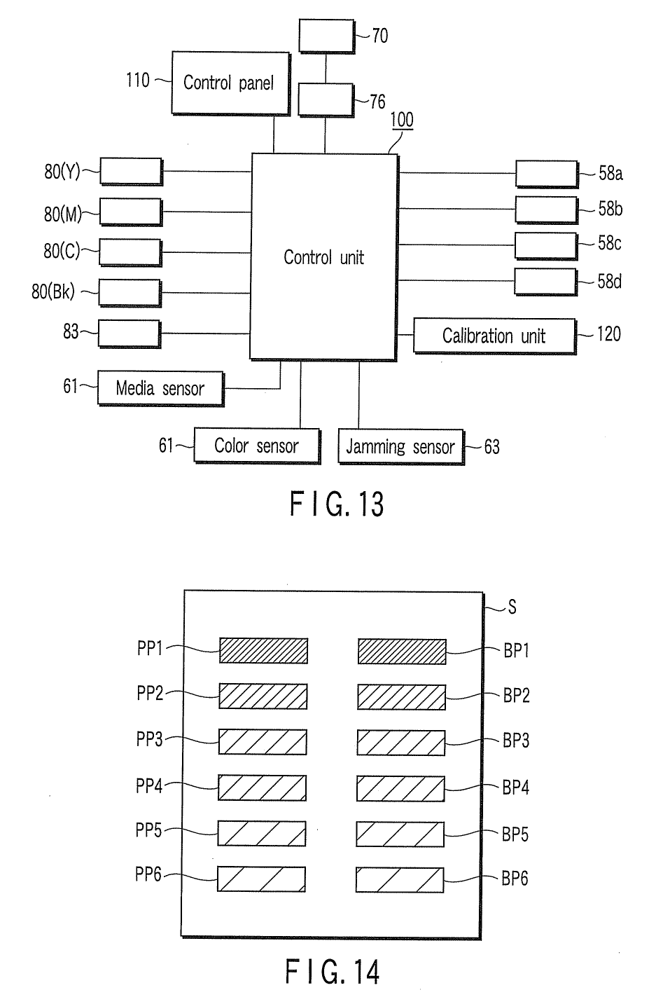

FIG. 13 is a block diagram showing a control system of the ink-jet recording apparatus 10. A control unit 100 that controls various kinds of information intensively, a control panel 110 for the user to make an input to the control unit 100, and a calibration unit 120 that performs a calibration operation described below, are provided.

In each of the cartridge loading units 50 for four colors, the terminals 58a through 58d that detect the information of the ink cartridge 200, the display unit 80 that displays a result as to whether the ink cartridge 200 is inserted into the right cartridge loading unit 50 on the basis of the read information, and a buzzer 83 are connected to the control unit 100. In addition, the outputs of the media sensor 61, the color sensor 62, and the jamming sensor 63 all attached to the housing 11 are connected to the same. Further, regarding the control unit 100, the control unit 100 controls the driver unit 76 of the pump 70 in such a manner that the pump 70 performs an ink supply operation only when the ink cartridge 200 is inserted into the right cartridge loading unit 50.

The ink-jet recording apparatus 10 configured as above is used as follows. Initially, the ink cartridge is loaded in the cartridge loading unit 50. In this instance, the loading operation is divided to the first stage at which the bottom portion of the ink cartridge 200 comes into contact with the damper units 55, and the second stage at which the ink receiving unit 52 is inserted into the seal 245 by pushing in the ink cartridge 200 against restoring forces of the coil springs 56 to further allow the protrusion 42 on the front of the ink cartridge 200 to be engaged in the bending portion 59a of the blade spring 59.

A difference between the first stage and the second stage is that a force needed for the user to insert the ink cartridge 200 is larger in the second stage than in the first stage owing to a force against the restoring forces of the coil springs 56. In short, the user is able to distinguish the first stage from the second stage clearly.

The detection, determination, and notification of the information about the ink cartridge 200 are performed in the first stage by transferring the information to the control unit 100 from the plate 43 of the ink cartridge 200 via the terminal 58 of the cartridge loading unit 50 for the control unit 100 to determine whether the ink cartridge 200 is inserted into the right cartridge loading unit 50, and by notifying the determination result in the form of a display using the display unit 80 and/or a sound of the buzzer 83.

Because the ink receiving unit 52 does not fit in the seal 245 in the first stage, the contact between the ink E on the ink cartridge 200 side and that of the cartridge loading unit 50 has not occurred. In this instance, when the ink cartridge 200 of the ink in the right color is loaded in the cartridge loading unit 50, the LED 81a is lit ON, and when the ink cartridge 200 of the ink in a wrong color is loaded in the cartridge loading unit 50, the LED 81a is blinked ON and OFF and the buzzer 83 sounds at the same time to alert the user by giving a notice, so that the user stops the loading operation before he proceeds to the second stage.

Herein, the LED 81a emits light in a color same as the normal color of the ink for the cartridge loading unit 50. For example, the LED 81a at the front of the cartridge loading unit 50, in which the ink cartridge 200Y for yellow is loaded, is a white LED covered with a yellow filter and thereby emits light in yellow. Further, by laminating a seal paper 230Y in yellow on the entire surface of the ink cartridge 200Y of yellow, the color of the ink cartridge 200 and the color of the LED 81a become the same when the right ink cartridge 200 is inserted, whereas the color of the ink cartridge 200 and the color of the LED 81a are different when a wrong ink cartridge 200 is inserted, which allows the user to know whether the operation is right or wrong with ease.

In this case, the LEDs 81a and 81b provided to each cartridge loading unit 50 as shown in FIG. 12 may be reduced to one. It is possible to notify the user whether the operation is right or wrong by lighting ON the LED 81a when the operation is determined as being right and blinking the LED 81a ON and OFF when the operation is determined as being wrong. Herein, the LED 81a emits light in a color same as the normal ink color for the cartridge loading unit 50.

It is thus possible to prevent a change in nature of the ink E by forestalling an ink in a different color from being mixed with the ink E.

In the second stage, the ink receiving unit 52 fits in the seal 245 of the ink cartridge 200, and the contact between the ink E on the ink cartridge 200 side and that of the cartridge loading unit 50 occurs.

Because the difference between the first stage and the second stage as described above enables the user to know whether the operation is right or wrong in the first stage at which the contact between the ink E on the ink cartridge 200 side and that of the cartridge loading unit 50 has not occurred, it is possible to stop the insertion operation of the ink cartridge 200 before the different inks E come into contact with each other even when a wrong ink cartridge is erroneously inserted. In addition, in the second stage, because it is necessary to push the ink cartridge 200 against the restoring forces of the coil springs, the user has to load the ink cartridge 200 with forces in two steps. Whether the right or wrong cartridge 200 is loaded is displayed when the user is on the point of increasing the force, it is possible to stop the loading operation easily before the ink E on the ink cartridge 200 side comes into contact with that on the cartridge loading unit 50.

After all the ink cartridges 200 are loaded in the corresponding cartridge loading units 50, an image is formed on a recording medium S. Initially, the image processing for recording is started by the image processing unit (not shown), and data for recording is transferred to the respective ink-jet recording heads 17Y through 17Bk. Meanwhile, recording media S set in the paper storing unit 14 are separated one by one at specific timing by the separation roller 21 and fed to the medium carrying unit 16 by the paper feeding rollers 22a and 22b. The recording medium S is then attracted onto the medium carrying belt 27, and carried to the opposing positions to the respective ink-jet recording heads 17Y, 17M, 17C, and 17Bk.

Firstly, the ink-jet recording head 17Y for yellow is operated to eject an ink in yellow from the nozzles for dots to land on the recording medium S. Subsequently, the ink-jet recording head 17M for magenta is operated to eject an ink in magenta from the nozzles for dots to land on the recording medium S. Subsequently, the ink-jet recording head 17C for cyan is operated to eject an ink in cyan from the nozzles for dots to land on the recording medium S. Lastly, when print in black is necessary, the ink-jet recording head 17Bk for black is operated to eject an ink in black from the nozzles for dots to land on the recording medium S, whereupon a color image is formed.

The calibration operation will now be described. Calibration is to adjust the densities of the respective colors by comparing a case where an image in gray is formed by an ink E prepared by mixing three colors including yellow, magenta, and cyan (process gray patch/comparison patch), and a case where an image in gray is formed using an ink E in black alone (gray patch by black/reference patch). To be more specific, to which level of grayscale in black the brightness of the process gray patch corresponds is detected. When the process gray patch and the gray patch by black are compared relatively with each other, they are compared in brightness by the color sensor 62. As is shown in FIG. 14, as the patches, patches PP1 through PP6 and BP1 through BP6 are formed at several grayscale levels on a sheet of paper S. A mixing ratio of three colors at which the process gray patch made by mixing three colors including yellow, magenta, and cyan becomes an achromatic color is calculated at several grayscale levels and compared with the gray patch by black. The result is fed back to the control unit 100 to control the image forming conditions, so that the density-to-grayscale characteristic is enhanced.

In the ink-jet method, an ink ejected from the ink-jet recording head lands on a sheet of paper and fixes thereon by being absorbed therein. The brightness of an image varies in this step. Because an image the user uses is an image after this step ends, it is necessary to perform calibration by detecting the brightness of an image in this state. It is therefore preferable to perform the detection when a specific time has passed since patches for calibration (FIG. 14) were printed, and the detection is made when one or more than one second, and preferably, three or more seconds have passed.

It is possible to perform precise calibration when a specific time has passed since the image was formed by performing a detection by adjusting a carrying speed of a sheet of paper or halting the sheet of paper at the position of the color sensor 62 after the patches are formed. In addition, in order to perform the calibration more precisely, detections are performed several times and when a difference in brightness falls within a specific range, the calibration is performed on the basis of this brightness.

The calibration operation is to control a driving voltage of the ink-jet recording head on the basis of a difference in brightness so as to eliminate the difference.

Concrete timing of the calibration will now be described. Because it is preferable to perform the calibration when a specific time has passed, the number of sheets of paper has reached a specific number, or when the ink cartridge is replaced with a new one, it is necessary to control the timing in the control unit 100.

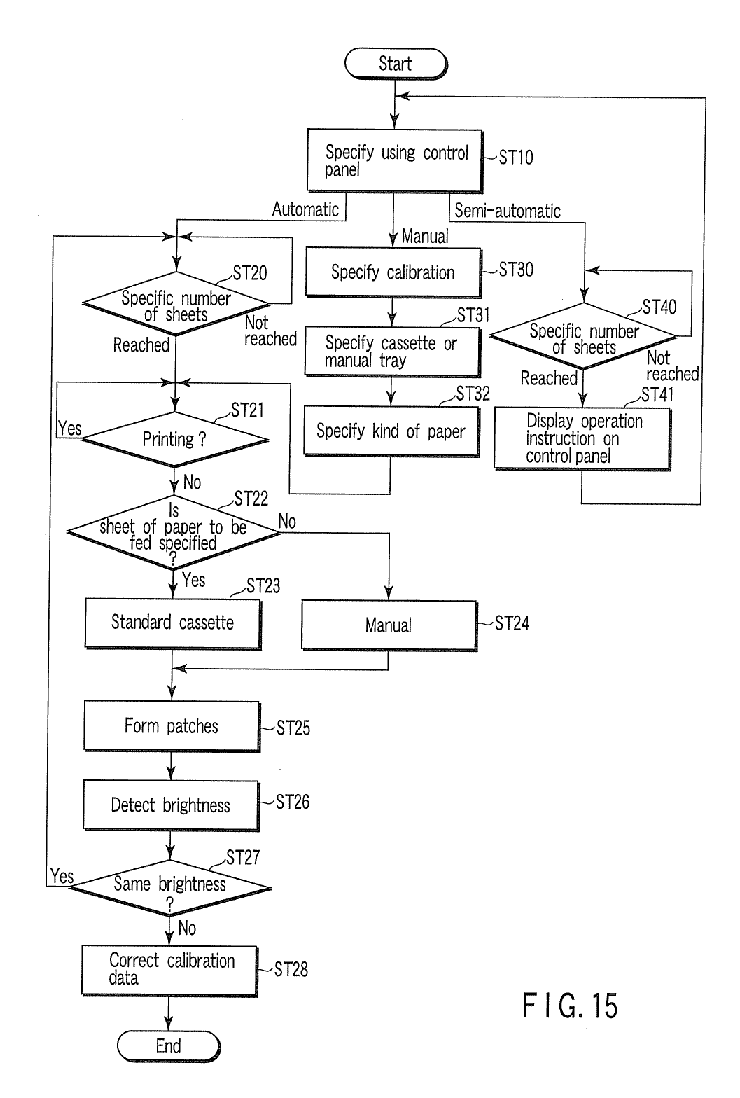

Descriptions will be given along the flowchart shown in FIG. 15. One out of three operations, “automatic”, “manual”, and “semi-automatic”, has been chosen previously for the calibration operation using the control panel 110 (ST10).

In a case where “automatic” is chosen, whether the number of sheets of paper has reached a specific number is determined (ST20). Whether printing is being executed is determined (ST21), and the calibration operation is started when printing is not being executed. Whether a sheet of paper to be fed is specified previously is detected (ST22), and a sheet of paper in the standard cassette is chosen when a sheet of paper is specified (ST23), whereas a sheet of paper on the manual tray is chosen when a sheet of paper is not specified (ST24), and gray patches are formed thereon (ST25).

The brightness is detected using the color sensor 62 (ST26), and the flow returns to ST20 when the patches have the same brightness to wait for the number of sheets of paper to reach a specific number (ST27). When the patches are different in brightness, the calibration data is corrected, and the operation is terminated (ST28).

Meanwhile, in a case where “manual” is chosen, the user specifies the calibration operation (ST30), chooses a sheet of paper (ST31), and designates the kind of paper (ST32), after which the flow proceeds to ST21 to perform the calibration operation.

In a case where “semi-automatic” is chosen, whether the number of sheets of paper has reached a specific number is determined (ST40), and when the number of sheets of paper has reached the specific number, such an indication is displayed on the control panel 110, and the flow returns to ST10.

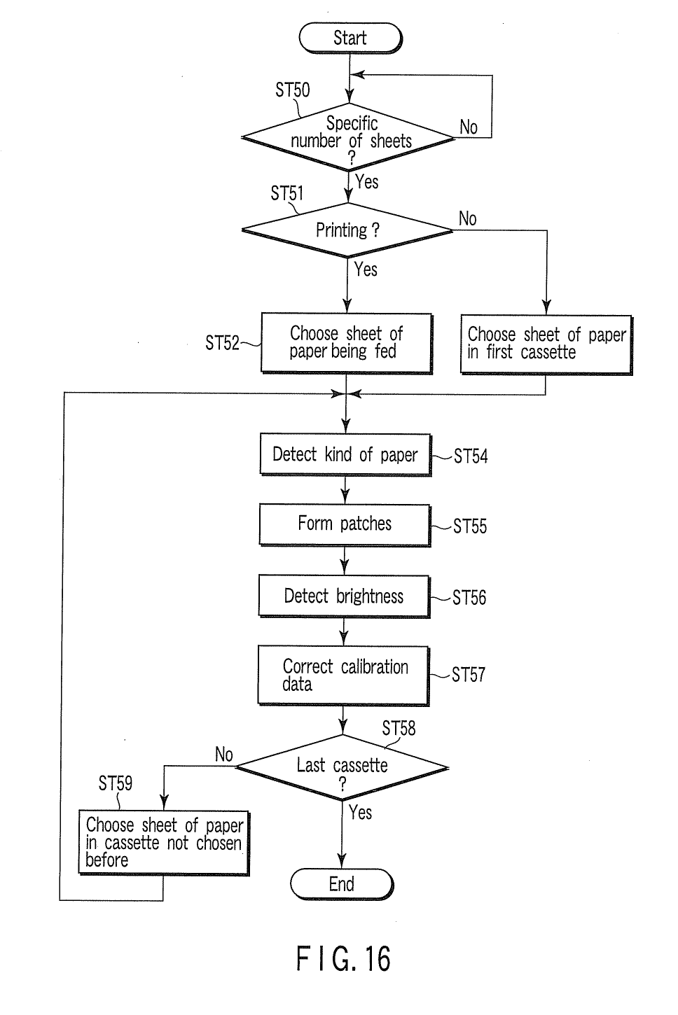

On the other hand, because the developed color of the gray patch differs with the kinds of paper, for an apparatus that uses different kinds of paper, the flowchart shown in FIG. 16 is configured to perform calibration appropriately for different kinds of paper.

Whether the number of sheets of paper has reached a specific number is determined (ST50), and whether printing is being executed is determined (ST51). When printing is being executed, a sheet of paper same as the one being fed is chosen (ST52), and when printing is not being executed, a sheet of paper in a first cassette is chosen (ST53).

Subsequently, the kind of paper is detected by the media sensor 61 (ST54), and gray patches are formed thereon (ST55). The brightness is detected by the color sensor 62 (ST56), and the calibration data is corrected (ST57). Whether the paper cassette is the chosen one is determined (ST58), and when the paper cassette is the last one, the operation is terminated. When the paper cassette is not the last one, a sheet of paper in a paper cassette that has not been chosen before is chosen (ST59), and the flow returns to ST54. In this manner, the calibration data is acquired for each kind of paper.

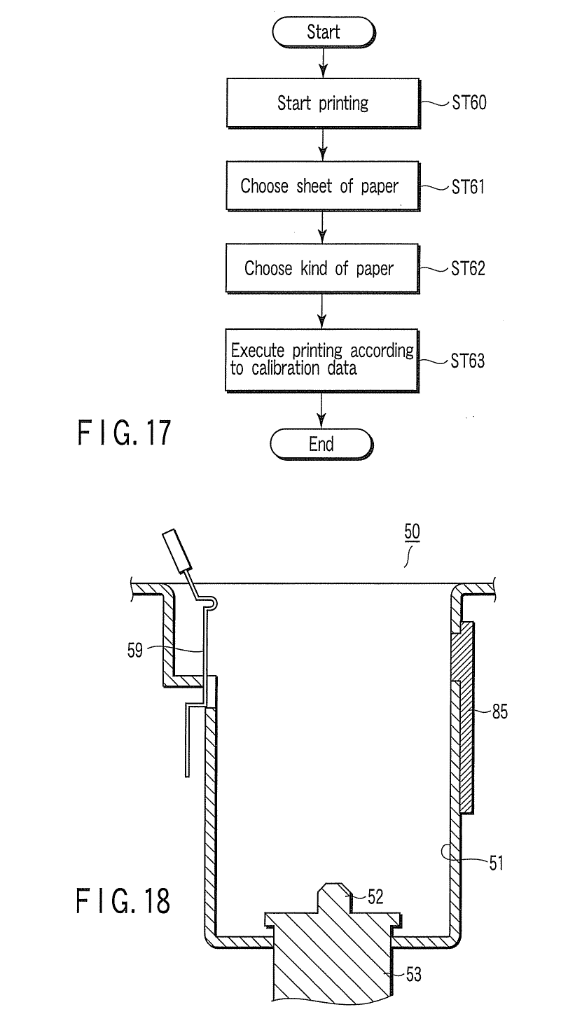

Further, the calibration data for each kind of paper acquired through calibration is used as follows. FIG. 17 is a flowchart to describe a printing operation using the calibration data.

When printing is started (ST60), a sheet of paper chosen previously by the user is chosen (ST61), based on which the calibration data is chosen according to the kind of paper (ST62), and printing is performed while correction is being made using the calibration data (ST63).

Hence, even when a kind of paper is different, it is possible to make a correction using most appropriate calibration data.

As has been described, according to the invention, when an ink cartridge is inserted into the cartridge loading unit (ink-jet recording apparatus main body), there is the first stage at which the bottom portion of the ink cartridge comes into contact with the damper units, and the second stage at which the ink cartridge is pushed in against restoring forces of the springs until the ink E on the ink cartridge side and that of the ink-jet recording apparatus main body come into contact with each other. In the first stage, the ink E on ink cartridge side and that on the ink-jet recording apparatus side neither come into contact with each other nor are mixed with each other. Hence, in the first stage, whether a right ink cartridge is loaded is determined by transferring information about the color of the ink in the ink cartridge 200 from the plate 220 attached to the ink cartridge 200 to the control unit 100 via the terminal 58 of the ink-jet recording apparatus 10, and the determination result is notified to the user in the form of a display or a sound. The user thus becomes able to know whether the operation is right or wrong in the first stage, which is a stage before the ink E on the ink cartridge side and that on the ink-jet recording apparatus main body side come into contact with each other. This prevents the contact between the ink E on the ink cartridge side and that on the ink-jet recording apparatus main body side.

Hence, the ink E is not deteriorated in the ink-jet recording apparatus, which makes it possible to provide an ink-jet recording apparatus having highly-reloadable, inexpensive, and reloadable ink cartridges of a common shape for all the colors. In addition, in the second stage, because it is necessary to push in the ink cartridge against the restoring forces of the springs in comparison with the first stage, the user becomes able to know whether the loading of the ink cartridge is right or wrong when a force needed to insert the ink cartridge has increased. It is therefore possible to stop the loading operation with ease before the ink E on the ink cartridge side and that on the ink-jet recording apparatus main body side come into contact with each other.

FIG. 18 is a cross section of a cartridge loading unit 50 when viewed in the side surface direction in a case where an RF tag is used for storing information about the ink cartridge 200 of this embodiment. It is a cross section of a major portion showing a modification. In FIG. 18, like reference numerals are labeled to portions having the same functions with respect to FIG. 3, and detailed description thereof is omitted herein.

In the embodiment described above, information about the ink color in the ink cartridge 200 is transmitted to the control portion 100 via the terminal 58 from the plate 43. However, as is shown in FIG. 17, it may be transferred to the control unit 100 via a reader 85 from an RF tag. In this case, an RF tag having stored the information about the ink cartridge 200 is laminated at the position of the plate 43 shown in FIG. 2.

Further, the reader 80 that reads out the information of the RF tag is attached at the position of the terminal 58 of FIG. 5. It is preferable that the reader 80 will not read out the information from the RF tag on the ink cartridge 200 inserted into the adjacent cartridge loading unit 50, and that the surface is sealed with a resin film so as not to be contaminated by the ink E. Hence, as a method for the RF tag, an electromagnetic induction method using transmissive medium waves over a short communication range is preferred. The position at which the RF tag is laminated is preferably almost the center in a direction orthogonal to the insertion direction of the ink cartridge 200 to prevent the reader 80 from reading out the information from the RF tag of the ink cartridge 200 inserted into the adjacent cartridge loading unit 50.

The modification described above is able to achieve the same advantages of the embodiment above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the invention as defined by the appended claims and equivalents thereof.

What is claimed is:

1. An ink-jet recording apparatus that performs recording on a recording medium by introducing inks from plural ink cartridges respectively accommodating inks in plural different colors including black, comprising:
plural heads that discharge the inks in plural colors toward the recording medium;
an image control unit configured to determine an image forming condition including a mixing ratio of the inks in plural colors to be ejected from the plural heads to the recording medium according to an image forming signal inputted from an outside;
plural cartridge loading units respectively corresponding to the plural ink cartridges and configured in such a manner that the respective ink cartridges are loaded therein in a reloadable manner;
a detection unit configured to detect whether the ink cartridges are loaded in the cartridge loading units as predetermined when the ink cartridges are loaded in the cartridge loading units; and
a calibration control unit configured to start a calibration operation when the detection unit detects proper loading.

2. The ink-jet recording apparatus according to claim 1, wherein the calibration control unit includes:
a comparative patch forming unit configured to form a gray comparative patch on the recording medium by mixing the inks in plural colors excluding black;
a reference patch forming unit configured to form a gray reference patch on the recording medium using the ink in black alone;
a brightness detection unit configured to detect brightness of the comparative patch and the reference patch formed on the recording medium; and
a correction unit configured to correct the image forming condition when the inks in plural colors are mixed according to a detection result by the brightness detection unit.

3. The ink-jet recording apparatus according to claim 2, wherein:
a detection by the brightness detection unit is performed when a specific time has passed since the comparative patch and the reference patch were printed.

4. The ink-jet recording apparatus according to claim 3, wherein:
a carrying speed of the recording medium is adjusted after the comparative patch and the reference patch are formed.

5. The ink-jet recording apparatus according to claim 3, wherein:
the recording medium is halted at a detection position of the brightness detection unit.

6. The ink-jet recording apparatus according to claim 2, wherein:
the correction unit controls driving voltages of the heads so that a difference between the brightness of the comparative patch and the brightness of the reference patch falls within a specific range.

7. An ink-jet recording apparatus that performs recording on a recording medium by introducing inks from plural ink cartridges respectively accommodating inks in plural different colors including black, comprising:
means for discharging the inks in plural colors from heads toward the recording medium;
means for detecting whether the ink cartridges are loaded in corresponding cartridge loading units;
means for determining an image forming condition including a mixing ratio of the inks in plural colors to be ejected to the recording medium according to an image forming signal inputted from an outside; and
means for performing a calibration operation when the ink cartridges are loaded properly.

8. The ink-jet recording apparatus according to claim 7, wherein the means for performing the calibration operation includes:
means for forming a gray comparative patch on the recording medium by mixing the inks in plural colors excluding black;
means for forming a gray reference patch on the recording medium using the ink in black alone;
means for detecting brightness of the comparative patch and the reference patch formed on the recording medium; and
means for correcting the image forming condition when the inks in plural colors are mixed according to the brightness detected.

9. The ink-jet recording apparatus according to claim 8, wherein:
the brightness is detected when a specific time has passed since the comparative patch and the reference patch were printed.

10. The ink-jet recording apparatus according to claim 9, wherein:
a carrying speed of the recording medium is adjusted after the comparative patch and the reference patch are formed.

11. The ink-jet recording apparatus according to claim 9, wherein:
the recording medium is halted at a brightness detection position.

12. The ink-jet recording apparatus according to claim 8, wherein:
driving voltages of the heads are corrected so that a difference between the brightness of the comparative patch and the brightness of the reference patch falls within a specific range.

13. A calibration method used in an ink-jet recording apparatus that performs recording on a recording medium by introducing inks from plural ink cartridges respectively accommodating inks in plural different colors including black, comprising the steps of:
discharging the inks in plural colors from heads toward the recording medium;
detecting whether the ink cartridges are loaded in corresponding cartridge loading units; determining an image forming condition including a mixing ratio of the inks in plural colors to be ejected to the recording medium according to an image forming signal inputted from an outside; and
starting a calibration operation when the ink cartridges are loaded properly.

14. The calibration method according to claim 13, wherein the calibration operation includes:
forming a gray comparative patch on the recording medium by mixing the inks in plural colors excluding black;
forming a gray reference patch on the recording medium using the ink in black alone;
detecting brightness of the comparative patch and the reference patch formed on the recording medium; and
correcting the image forming condition when the inks in plural colors are mixed according to the brightness detected.

15. The calibration method according to claim 14, wherein:
the brightness is detected when a specific time has passed since the comparative patch and the reference patch were printed.

16. The calibration method according to claim 15, wherein:
a carrying speed of the recording medium is adjusted after the comparative patch and the reference patch are formed.

17. The calibration method according to claim 15, wherein:
the recording medium is halted at a brightness detection position.

18. The calibration method according to claim 14, wherein:
driving voltages of the heads are corrected so that a difference between the brightness of the comparative patch and the brightness of the reference patch falls within a specific range.
